(19) United States
(12) Patent Application Publication
(10) Pub. No.: US 2024/0354294 A1
(43) Pub. Date: Oct. 24, 2024

(54) METHOD TO STORE DATA ASSOCIATED TO MEMBERS OF ENTITIES OF A DATABASE

(71) Applicants: Franco ROSI, Lugano (CH); Natzka SA, Lugano (CH)

(72) Inventor: Franco ROSI, Lugano (CH)

(21) Appl. No.: 18/580,666

(22) PCT Filed: Jul. 29, 2021
(86) PCT No.: PCT/IB2021/056919

§ 371 Date: Jan. 19, 2024

(51) Int. Cl. G06F 16/22

(52) U.S. Cl. CPC G06F 16/2282; G06F 16/2237

(57) ABSTRACT

A method for organising data into data structures and accessing data in those structures is described. Starting with a tabular structure, each row is coded as a first and second macro number, which are stored in a configuration structure. A pre-mapping is captured from the data structure, wherein the second macro numbers are stored without repetition in a pre-mapping structure with segments i, with a number K of second numbers. A pointing function to the second macro numbers from the first macro numbers is also implemented via bitmaps with K bits, wherein a bitmap i is allocated for a first macro number only if the first macro number in the configuration structure is in a row that also contains the second macro number, and the second macro number is in segment i in the pre-mapping structure. A method for accessing data stored in the aforementioned structures is also described.

### SCOPE OF APPLICATION

The present invention relates to a method for storing data, with each value associated with multiple members of entities defined in a database.

The present invention also relates to a method for accessing stored data.

The invention also relates to a system for storing and accessing the aforementioned data by electronic, especially computerised, means.

### PRIOR ART

There are known methods for storing data associated with members of respective entities in a database. For example, the database may be a relational database made up of tables. Each table is set up to store numerous rows, and each row is associated with a unique ID. Each table A also includes one or more columns, each associated with a certain entity.

By way of example, and to aid understanding, consider a simple table A in the database, which may include three columns associated with the entities “month”, “customer” and “product” respectively.

This example is not limiting, and table B in the database, populated with more columns, may comprise the entities “Month”, “Corporate Account”, “Company”, “Cost Center”, “Controlling”, “Activity”, “Product”, “Destination”, “Source”, “Scenario”, “Version” and “Line Item”. In this second example table B therefore includes twelve entities.

The rows in table A or B are set up to store a member for each entity of a column. In other words, a row in table A stores an ID, for example id1, and contains the members “January”, “customerA”, “Product100”. Obviously numerous rows can be stored in table A, as in the example below.

### Table A

id1, “January”, “customerA”, “Product100”, 10
id2, “January”, “customerB”, “Product101”, 12
id3, “January”, “customerA”, “Product102”, 20
id4, “January”, “customerA”, “Product103”, 22
id5, “January”, “customerB”, “Product100”, 21
id6, “February”, “customerA”, “Product100”, 20
id7, “February”, “customerA”, “Product101”, 10
id8, “January”, “customerA”, “Product106”, 20,

The numerical value shown above after Product is, for example, stored in a fourth column in table A, and represents the amount of product bought by customerX in a given month. idx represents the unique ID of each row, and is only indicated above with alphanumerical rather than numerical characters for the sake of simplicity.

Continuing with the example, table B could contain the following rows (each row starting with the ID):
Id1, “January”, “Corporate Account 1”, “Company A”, “Cost Center 1”, “Controlling CTR1”, “Activity ACT1”, “Product 100”, “Destination DEST1”, “Source SRC”, “Scenario SNR”, “Version 1.0”, “Line Item LINE1”, 10
Id2, “January”, “Corporate Account 1”, “Company A”, “Cost Center 2”, “Controlling CTR1”, “Activity ACT1”, “Product 200”, “Destination DEST1”, “Source SRC”, “Scenario SNR”, “Version 1.0”, “Line Item LINE1”, 12
Id3, “January”, “Corporate Account 2”, “Company A”, “Cost Center 3”, “Controlling CTR1”, “Activity ACT1”, “Product 200”, “Destination DEST1”, “Source SRC”, “Scenario SNR”, “Version 2.0”, “Line Item LINE1”, 20
Id4, “January”, “Corporate Account 2”, “Company A”, “Cost Center 3”, “Controlling CTR1”, “Activity ACT1”, “Product 200”, “Destination DEST1”, “Source SRC”, “Scenario SNR”, “Version 2.0”, “Line Item LINE2”, 50
Id5, “January”, “Corporate Account 1”, “Company A”, “Cost Center 3”, “Controlling CTR2”, “Activity ACT1”, “Product 100”, “Destination DEST1”, “Source SRC”, “Scenario SNR”, “Version 2.0”, “Line Item LINE2”, 30
Id6, “February”, “Corporate Account 1”, “Company A”, “Cost Center 3”, “Controlling CTR2”, “Activity ACT1”, “Product 100”, “Destination DEST1”, “Source SRC”, “Scenario SNR”, “Version 1.0”, “Line Item LINE2”, 70
Id7, “February”, “Corporate Account 1”, “Company A”, “Cost Center 3”, “Controlling CTR2”, “Activity ACT1”, “Product 200”, “Destination DEST1”, “Source SRC”, “Scenario SNR”, “Version 1.0”, “Line Item LINE2”, 25
Id8, “February”, “Corporate Account 1”, “Company A”, “Cost Center 3”, “Controlling CTR2”, “Activity ACT1”, “Product 200”, “Destination DEST1”, “Source SRC”, “Scenario SNR”, “Version 2.0”, “Line Item LINE2”, 7

The data structures above are fairly effective when access to one row is required, as typically occurs in a transactional system. However, they have considerable disadvantages in applications that require bulk queries, as in the case of business intelligence systems, where access is required not only to one row, but to multiple rows. The aforementioned data structures and corresponding management systems also suffer, because their correct operation depends on tables being re-indexed as a result of storing new records (rows).

An example of a critical situation would be when table B comprises billions of rows (or more) before or after the eight rows represented above or placed in between them, and querying table B involves extracting just one row or a subset of rows. For example, a query could ask to determine, in simple table A, how many units of product 100 were purchased by customer A in January, or in the more complex table B, how many units of product A, version 2.0 were purchased by Company A with destination DEST 1 and source SRC, in scenario SNR.

In the example above, this query would involve higher response times and hardware resources that are not insignificant.

The technical problem underlying the present invention is that of devising a data storage method and a data access method that are more efficient in terms of storage space and time, and response times, basically overcoming the issues that have affected known systems and methods up until now.

### SUMMARY OF THE INVENTION

To summarise without being exhaustive (a subsequent description is provided), the idea behind the present invention is to create a method for organising data which, starting with a known tabular structure, as is typically found in a relational system, codes each row as a first and second macro number and stores these macro numbers in a configuration structure (CONF). A pre-mapping is then captured from the configuration structure, where the second macro numbers are stored without repetition in a pre-mapping structure (PRE) with segments Si, where each segment Si has a number K of second macro numbers. The first macro numbers point to the second macro numbers via bitmaps with K bits, whereby a bitmap MAP i is allocated to the first macro number only if the first macro number in the configuration structure (CONF) is stored in association with the second macro number, and the second macro number is in segment Si of the pre-mapping structure (PRE).

As stated, the method is described in full below, in particular in relation to the configuration and pre-mapping phases.

Data which is stored in rows and columns of a table in a relational system, is organised according to the method of the present invention into a first subset of members in a row, and a second subset of members in the row.

The first subset of members in the row is coded as a first macro number M1, and the second subset of members in the row is coded as a second macro number M2.

A member in the row is not coded and is indicated below as the value VAL.

The first macro numbers M1 and the second macro numbers M2 are stored in a row structure CONF, also termed a configuration structure, where each row includes the first macro number M1, the second macro number M2, and the value VAL.

The configuration structure CONF is used for a data pre-mapping (of the first and second macro numbers) as follows.

The second macro numbers M2 are stored in a pre-mapping structure PRE without repetition. The pre-mapping structure PRE is split into segments Si (i=0, . . . , n), where each segment comprising a set number K (e.g. 2400) of second macro numbers M2.

Each of the first macro numbers M1 can point to bitmaps MAP, each comprising a set number K of bits corresponding to a set number K of second macro numbers M2 in the segments Si of the second macro numbers M2.

The bitmaps MAP are used to track the positions in the segments Si of the second macro numbers M2, which are associated with the first macro number M1 in the configuration structure CONF.

A bit map MAP i is allocated such that a first macro number M1 points to it, only if the first macro number M1 in the configuration structure CONF is stored in association with the second macro number M2, and the second macro number M2 is in segment Si of the pre-mapping structure PRE. An example is provided in the description below.

In this case, the bit in position k (with k=0, . . . , K) of bitmap MAP i is set to indicate the position k in segment Si of the second macro number M2 associated with the first macro number M1.

Furthermore, the value VAL associated with the first macro number M1 and the second macro number M2 is stored in association with the bitmap MAP i.

The values VAL in the bitmap MAP i are stored consecutively, without having to provide or allocate storage space at K set positions, thereby specifying a pre-mapping data structure PRE split into segments Si of second macro numbers M2 without repetition and with the first macro numbers M1 pointing at bitmaps MAP, with a bitmap MAP i for a first macro number M1 allocated only in specific conditions however, which are those outlined above.

The method for querying the data structures organised in this manner is as follows.

Querying involves determining the values VAL that satisfy certain criteria, which are associated for example with a member SUB2 coded within a second macro number M2 and a member SUB1 coded within a first macro number M1. This member SUB2 is the coding for one or more members of the initial tabular structure.

In this case, a search is performed for the number SUB2 in the second macro numbers M2 in the pre-mapping structure PRE, to determine all segments Si that contain the second macro numbers M2 including the number SUB2.

Via the indexes i of the segments determined in this manner, it is possible to access only the bitmaps MAP i pointed at by the first macro number M1 which includes the number SUB1.

The values VAL in the bitmap MAP i are then read. These values VAL constitute the result or target of the query.

The description that follows has some embodiment examples that use a mathematical coding formula in the first macro numbers M1 and the second macro numbers M2 of the data stored in tabular format, such as in the tables of a relational database.

However this mathematical formula is not restrictive, as it can be replaced by an alternative formula with the aim of mapping the members in first and second macro numbers.

The description that follows is therefore purely an illustrative example and is not limiting with regard to the present invention.

### BRIEF DESCRIPTION OF THE ACCOMPANYING DIAGRAMS

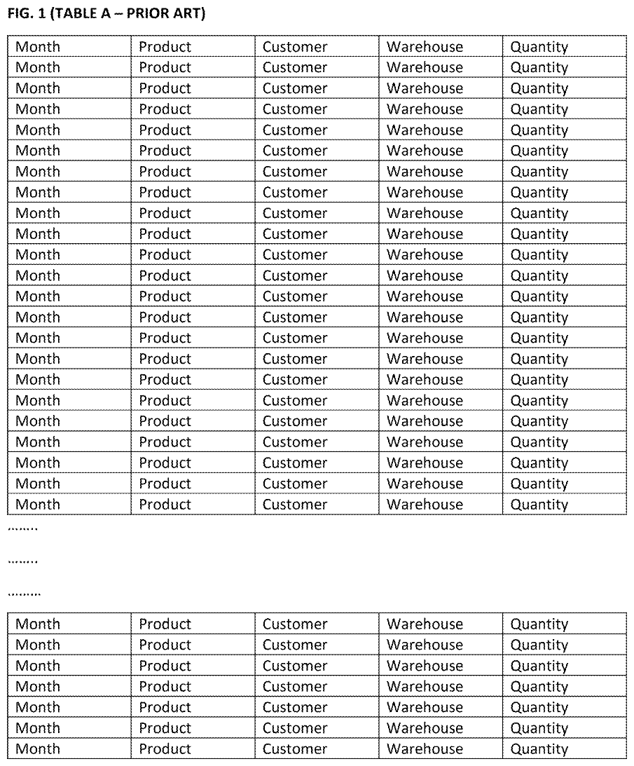

FIG. 1 is a table of rows and columns according to the prior art.

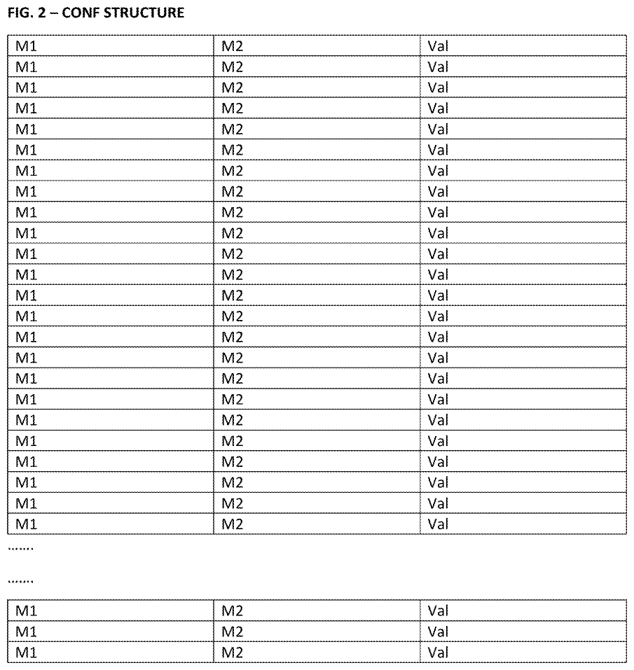

FIG. 2 is a configuration structure CONF according to the present invention.

FIG. 3 is a pre-mapping structure CONF according to the present invention.

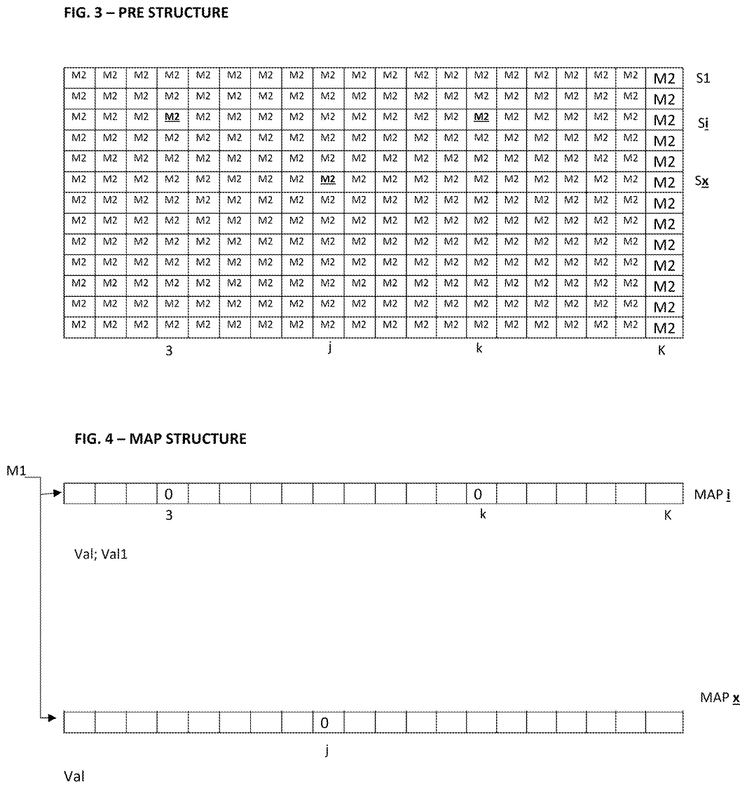

FIG. 4 shows bitmaps MAP according to the present invention.

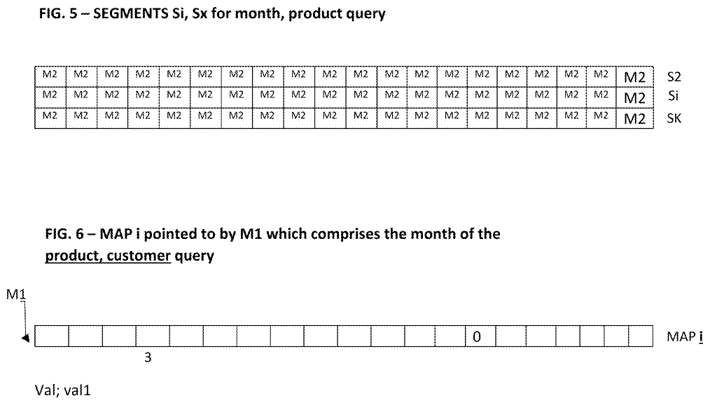

FIG. 5 schematically represents access to the pre-mapping structure PRE in a query phase according to the present invention.

FIG. 6 schematically represents a bitmap MAP in a query phase according to the present invention.

### DESCRIPTION OF AN EMBODIMENT OF THE PRESENT INVENTION

An example embodiment of the present invention is provided below, and in particular a method implemented by electronic, especially computerised, means for storing data.

The example provided is purely for clarity and illustration, and does not limit the invention's scope of protection, which is defined in the claims.

The data to be stored is associated with members of respective entities in a database, such as with members and entities in the tables defined with reference to the prior art, as outlined below.

### Example 1

“January”, “customerA”, “Product100”, 10
“January”, “customerB”, “Product101”, 12
“January”, “customerA”, “Product102”, 20
“January”, “customerA”, “Product103”, 22
“January”, “customerB”, “Product100”, 21
“February”, “customerA”, “Product100”, 20
“February”, “customerA”, “Product101”, 10
“January”, “customerA”, “Product106”, 20,

### Example 2

“January”, “Corporate Account 1”, “Company A”, “Cost Center 1”, “Controlling CTR1”, “Activity ACT1”, “Product 100”, “Destination DEST1”, “Source SRC”, “Scenario SNR”, “Version 1.0”, “Line Item LINE1”, 10
“January”, “Corporate Account 1”, “Company A”, “Cost Center 2”, “Controlling CTR1”, “Activity ACT1”, “Product 200”, “Destination DEST1”, “Source SRC”, “Scenario SNR”, “Version 1.0”, “Line Item LINE1”, 12
“January”, “Corporate Account 2”, “Company A”, “Cost Center 3”, “Controlling CTR1”, “Activity ACT1”, “Product 200”, “Destination DEST1”, “Source SRC”, “Scenario SNR”, “Version 2.0”, “Line Item LINE1”, 20
“January”, “Corporate Account 2”, “Company A”, “Cost Center 3”, “Controlling CTR1”, “Activity ACT1”, “Product 200”, “Destination DEST1”, “Source SRC”, “Scenario SNR”, “Version 2.0”, “Line Item LINE2”, 50
“January”, “Corporate Account 1”, “Company A”, “Cost Center 3”, “Controlling CTR2”, “Activity ACT1”, “Product 100”, “Destination DEST1”, “Source SRC”, “Scenario SNR”, “Version 2.0”, “Line Item LINE2”, 30
“February”, “Corporate Account 1”, “Company A”, “Cost Center 3”, “Controlling CTR2”, “Activity ACT1”, “Product 100”, “Destination DEST1”, “Source SRC”, “Scenario SNR”, “Version 1.0”, “Line Item LINE2”, 70
“February”, “Corporate Account 1”, “Company A”, “Cost Center 3”, “Controlling CTR2”, “Activity ACT1”, “Product 200”, “Destination DEST1”, “Source SRC”, “Scenario SNR”, “Version 1.0”, “Line Item LINE2”, 25
“February”, “Corporate Account 1”, “Company A”, “Cost Center 3”, “Controlling CTR2”, “Activity ACT1”, “Product 200”, “Destination DEST1”, “Source SRC”, “Scenario SNR”, “Version 2.0”, “Line Item LINE2”, 7

Another example is provided in FIG. 1 attached (which basically corresponds to example 1 above but with one entity more i.e. Warehouse).

The method according to the present invention involves first and foremost a configuration phase, which is illustrated below.

The data stored in the table (in FIG. 1 in this case) is coded as numbers, where each row of the table is associated with at least one first macro number and a second macro number, in order to obtain a configuration structure CONF of the type represented schematically in FIG. 2.

In said FIG. 2 the first macro number is indicated with M1 and the second macro number is indicated with M2. In each row of the configuration table CONF in FIG. 2, M1 for example codes the member month in a row in the FIG. 1 table, and M2 for example codes the members product, customer and warehouse in the row of the FIG. 1 table, basically coding them in just one second macro number M2.

Other member groupings are possible however, for example M1 could code the month and product, and M2 could code the customer and warehouse.

The quantity, also called the value VAL, is not coded and is already a number.

The method for coding the members in the FIG. 1 table as first M1 and second M2 macro numbers in the CONF structure is not limiting for the present invention.

An embodiment is provided below relating to example 1, without being exhaustive.

Coding may, for example, consist of the following possible “M1”, “M2” associations.

| (“M1, | M2) |
|---|---|
| “1”, | “10001” (row 1) |
| “1”, | “20002” (row 2) |
| “1”, | “10003” (row 3) |
| “1”, | “10004” (row 4) |
| “1”, | “20001” (row 5) |
| “2”, | “10001” (row 6) |
| “2”, | “10002” (row 7) |
| “1”, | “10005” (row 8) |

The first macro number 1 (M1) in row 1 is associated with the member “January” in the month entity.

The first macro number 2 (M1) in row 6 is associated with the member “February” in the month entity.

Other months could be associated with the first macro number using progressive numbers. For example, 3 could represent the month of March in a given year (e.g. 2020, the same as month 1), 12 could represent the month of December (in 2020), 13 the month of January in the following year (2021) etc.

The second macro number 10001 in row 1 codes a first and second sub-number, which are associated with the respective members of example 1. In particular, in the second macro number 10001 (M2), 1 (the digit on the left) is associated with the member customerA and 1 (the digit on the right) is associated with the member Product 100.

A formation of first and second macro numbers will be predefined.

For example, the second macro number could be made up of two sub-numbers—a first sub-number representing the product, between 1 and the maximum value of integers manageable by a processor divided by the product of the maximum number of entity members that follow, and a second sub-number between 1 and 9999.

However, this format is not limiting. In other words, as already stated with regard to coding members as first and second macro numbers, also the size and format of first and second macro numbers, and the size and format of sub-numbers coded therein, are not limiting for the present invention.

Of significance here is the potential for coding members, such as the members of the FIG. 1 table, as first M1 and second M2 macro numbers, similar to those represented schematically in FIG. 2, and the potential for decoding the first M1 and second M2 macro numbers to go to their constituent sub-numbers, and then go to the corresponding members of the FIG. 1 table.

On the basis of the above, the remaining seven rows in example 1, shown again below,
“1”, “20002”
“1”, “10003”
“1”, “10004”
“1”, “20001”
“2”, “10001”
“2”, “10002”
“1”, “10005”
respectively represent the association of sub-numbers
2 with customerB,
2 with Product101
3 with Product102
4 with Product103
5 with Product106

It is extremely important to observe that the macro number M1 can also code a first and second sub-number (or multiple sub-numbers).

Grouping sub-numbers in the first macro number M1 and in the second macro number M2 enables data structures to be queried efficiently, and can be determined according to application requirements.

Following the configuration phase, which terminates by creating and populating the CONF structure exemplified in FIG. 2, the second macro numbers M2 are stored in a pre-mapping structure PRE split into segments Si. This phase is also known as pre-mapping. The pre-mapping structure PRE only includes the second macro numbers M2.

Each of the segments Si (S1, S2, . . . ) in the PRE structure comprise a predetermined number K (e.g. 2400) of second macro numbers M2. A representation is given by way of example with reference to FIG. 3.

The second macro numbers M2 in the PRE structure are shown just once. Therefore, while the CONF structure has X rows for example, and hence X second macro numbers M2, some of which are repeated once or several times, the PRE structure only includes Y second macro numbers M2, with Y<X.

The number of segments Z is basically equal to the number Y of second macro numbers M2 in the PRE structure divided by the size K of the segments Si, in other words Z=Y/K.

The pre-mapping phase concludes with the PRE structure of the type represented schematically in FIG. 3.

Subsequently, continuing according to the method of the present invention and in a phase where the structures are still being created and populated, even before the data structures are queried, the first macro numbers M1 are pointed to the second macro numbers M2 in the PRE structure.

This point setup phase is implemented via bitmaps MAP of the type represented in FIG. 4.

Each bitmap MAP comprises K bits.

In particular, if we consider a first macro number M1 in the CONF structure, this first macro number is associated with a second macro number M2. The second macro number M2 is stored in the PRE structure in a segment Si and, within said segment Si, in a position k. Therefore a bitmap MAP i is created for the first macro number M1 considered i.e. a bit is set to position k within this bitmap MAP i. It should be noted that the size of the bitmaps MAP is very small, with each of the K elements occupying 1 bit of memory.

In this phase, and still in relation to FIG. 2 and the CONF structure, the value VAL is stored in association with the bitmap MAP, linking the first macro number M1 and the second macro number M2 considered.

It is important to note that, according to the present invention, it is provided to store the values VAL consecutively and not in an indexed fashion. This expedient allows a further saving of space.

To go to the value VAL associated with a certain second macro number M2 pointed at via the bitmap MAP i from the first macro number M1, it is indeed provided to count the number of set bits that precede the bit associated with the second macro number M2, thereby obtaining its position pos in the bitmap MAP i, and then the relevant number VAL determined i.e. that which has the same position pos among the values VAL associated with the bitmap MAP i.

Therefore on completion of this phase a certain number of bitmaps MAP i will be allocated. Referring to FIG. 4 for example, the bitmap MAP i and the bitmap MAP x were allocated for the first macro number M1. Two bits are set in position 3 and k in the bitmap MAP i, and just one is set in position j in the bitmap MAP x. Two values, Val and Val1 are stored in association with the bitmap MAP i, and just one value, Val, is stored in association with the bitmap MAP x. Position 3 with k set bits in the bitmap MAP i corresponds to position 3 with k in segment Si of the second macro numbers M2 associated with the first macro number M1. Position j of the bit set in the bitmap MAP x corresponds to position j in segment Sx of the second macro numbers M2 associated with the first macro number M1.

On completing this phase pre-mapping has concluded, and the overall data structure of the method according to the present invention is ready for use, to perform a query for example.

Obviously M1, M2 and Val have been used symbolically and for simplicity in the structures in FIGS. 2, 3 and 4, but these labels (M1, M2, Val) represent numbers that potentially differ from each other.

The querying phase is described using FIGS. 5 and 6.

Without limiting the invention's scope of application, referring to the structures in FIGS. 2 and 3, a query may be performed on a specific month and a specific product e.g. to determine the product quantity sold in a given month, irrespective of the customer or warehouse.

According to the information above, the month will be coded as the first macro number M1, and the product will be coded as the second macro number M2, in particular as a sub-number of the second macro number M2.

This is how a query is implemented according to the method of the present invention.

First of all the segments S are identified, which contain the second macro numbers M2 in the pre-mapping structure PRE, which in turn contain the product of interest (i.e. the sub-number associated with the product of interest). The segments Si and Sg for example are found in this manner. More segments can be identified as the product of interest may be in more than one second macro number M2 in the PRE structure.

The bitmaps MAP which correspond to segments Si and Sg are then accessed.

However, in the example provided, there is no bitmap MAP g for the number M1. Therefore the values VAL i.e. the product quantity sold, will only be searched in association with the map MAP i. Identifying these values and, in the specific example provided, their sum, determines the result of the query (how many ‘product’ products were sold in a given ‘month’ month).

The present method, after a relatively onerous configuration and pre- mapping phase, offers astonishing application benefits.

In practice, it makes it possible to avoid indexing tables.

All data items are coded as numbers (first macro numbers and second macro numbers) and searching the numbers in the structure is an extremely quick process.

Bitmaps are very efficiently managed in terms of space and time.

Modelling the structure further accelerates search times. For this purpose, it is beneficial to code entities which are fewer in number in the first macro numbers M1 (e.g. months and products, which are normally fewer than customers and warehouses). By doing so, the values VAL of interest are counted on a lower number of bitmaps MAP, after filtering only the second macro numbers M2 of potential interest in the search as efficiently as mentioned above.

The applicant has performance tested the method to this effect. Compared with others taken as a benchmark, it boasts much quicker response times in data searches, and significantly less storage is used for the CONF, PRE and bitmap MAP structures.

1. Method implemented by electronic means to store data in structures (CONF, PRE, MAP) and organise access to data in said structures (CONF, PRE, MAP), wherein the data initially stored in rows and columns of a database table is organised, by row, into a first subset of members in the row and a second subset of members in the row, wherein the first subset of members in the row is coded as a first macro number (M1), and the second subset of members in the row is coded as a second macro number (M2), and wherein a member of the row, defined as value (VAL), is not coded, and wherein the first macro numbers (M1) and the second macro numbers (M2) are stored in a configuration structure (CONF) in which the first macro number (M1), the second macro number (M2) and the value (VAL) are stored in association,
the configuration structure (CONF) is used to carry out a data pre-mapping wherein
the second macro numbers (M2) are stored in a pre-mapping structure (PRE) without repetition and the pre-mapping structure (PRE) is split into segments Si (i=0, . . . , n), each comprising a set number K of second macro numbers (M2),
each of the first macro numbers (M1) can point to bitmaps (MAP), each bitmap (MAP) comprising a set number K of bits corresponding to the set number K of second macro numbers (M2) in the segments Si of the second macro numbers (M2), and wherein
the bitmaps (MAP) are used to track positions in the segments Si of the second macro numbers (M2), which are associated with the first macro number (M1) in the configuration structure CONF and wherein
a bitmap (MAP i) is allocated to be pointed to by a first macro number (M1) only if the first macro number (M1) in the structure (CONF) is stored in association with the second macro number (M2) and the second macro number (M2) is in segment i of the pre-mapping structure (PRE), and in this case, the bit in position k (with k=0, . . . , K) of the bitmap (MAP i) is set to indicate position k in segment Si of the second macro number (M2) associated with the first macro number (M1), and the value (VAL) associated with the first macro number (M1) and the second macro number (M2) is stored in association with the bitmap (MAP i), and wherein
the values (VAL) are stored in the bitmap (MAP i).

2. Method according to claim 1 wherein the first macro numbers (M1) and the second macro numbers (M2) are stored in the configuration structure (CONF) with the first macro number (M1), the second macro number (M2) and the value (VAL) in the same row of the configuration structure (CONF), in separate columns of said row.

3. Method according to claim 1 wherein the bitmap (MAP i) is allocated to be pointed to by the first macro number (M1) only if the first macro number (M1) in the structure (CONF) is in a row that also contains the second macro number (M2).

4. Method according to claim 1 wherein the values (VAL) in the bitmap (MAP i) are stored consecutively, without having to provide or allocate a storage space at K set positions.

5. Method for querying data structures organised according to claim 1, including phases to
determine the values (VAL) associated with a member (SUB2) coded within a second macro number (M2) and with a member (SUB1) coded within a first macro number (M1),
search the member (SUB2) within the second macro numbers (M2) in the structure (PRE), to determine all segments Si that contain the second macro numbers (M2) including the member (SUB2),
via the indexes i of determined segments, access only the bitmaps (MAP i) pointed to by the first macro number (M1) that includes the member (SUB1), read the values (VAL) in the bitmap (MAP i) as per the query result.
